(19) United States
(12) Patent Application Publication
(10) Pub. No.: US 2021/0396495 A1
(43) Pub. Date: Dec. 23, 2021

(54) ARMOR INCLUDING WOVEN AND UNIDIRECTIONAL FABRIC LAYERS AND METHODS OF FORMING ARMOR

(71) Applicants: Nicholas L. Ciparro, Knoxville, TN (US); Bowie J. Benson, Knoxville, TN (US); Jedidiah L. Long, Clinton, TN (US); Austin X. Staub, Knoxville, TN (US)

(72) Inventors: Nicholas L. Ciparro, Knoxville, TN (US); Bowie J. Benson, Knoxville, TN (US); Jedidiah L. Long, Clinton, TN (US); Austin X. Staub, Knoxville, TN (US)

(21) Appl. No.: 17/354,802

(22) Filed: Jun. 22, 2021

Related U.S. Application Data
(60) Provisional application No. 63/042,133, filed on Jun. 22, 2020.

(51) Int. Cl. F41H 5/04

(52) U.S. Cl. CPC F41H 5/0428; B32B 5/024

(57) ABSTRACT

An armor and a method of forming an armor. The armor comprising a lamination comprising a plurality of alternating stacks of fabric layers. The alternating stacks of fabric layers include a woven fabric layer and a unidirectional fabric layer.

### PRIORITY CLAIM

This application claims the benefit under 35 U.S.C. § 119(e) of U.S. Provisional Patent Application Ser. No. 63/042,133, filed Jun. 22, 2020, the disclosure of which is hereby incorporated herein in its entirety by this reference.

### TECHNICAL FIELD

Embodiments of the disclosure relate to armor including woven and unidirectional fabric layers, methods of forming armor and applications thereof.

### BACKGROUND

The current standard technology for ballistic armor serving for bodily rifle protection is MJ Standard 0101.06 level III and level IV. For vehicular and structural protection, the standard is NIJ 0108.01. Similarly, STANAG and UL, etc. standards are published for bodily and vehicular protection. Products conforming to these standards are typically manufactured as hard, stiff plate-based systems that are combination of pressed or bound polymer infused fiber composites and/or solid materials (e.g., metals and/or ceramics). With increasing threat levels due to improved availability and development of projectiles with enhanced lethality and penetration severity, ballistic protection must advance accordingly.

The development of armor for personnel protection includes a multi-part system that may be composed of a strike face. Strike faces may be comprised of hard ceramic plates or tiled ceramic arrangements that can be materials such as alumina (Al₂O₃), silicon carbide (SiC), boron carbide (B₄C), silicon nitride (Si₃N₄), boron suboxide (B₆O), titanium diboride (TiB₂), as well as various other nanocomposites and mixtures thereof. Of these materials, the most common are alumina, silicon carbide, and boron carbide. This hard-ceramic plate or tiled arrangement is used to disintegrate and ablate the projectile before it reaches the projectile capturing backing plate.

The backing plate functions to capture the penetrator as well as any accelerated strike face fragments and may be composed of any layered combination of woven, non-woven and/or unidirectional fabrics as well as composites. Armor may be manufactured into different configurations that are flexible, thin, and lightweight, with multi-round rifle-resistant capability according to applicable industry standards (e.g., NIJ, STANAG, and/or UL).

### BRIEF SUMMARY

Embodiments described herein include an armor and method of forming an armor. For example, in accordance with one embodiment described herein, an armor comprises a lamination comprising a plurality of alternating stacks of fabric layers. The alternating stacks of fabric layers include a woven fabric layer and a unidirectional fabric layer.

In additional embodiments, a method of forming an armor is disclosed. The method comprises providing a plurality of alternating stacks of fabric layers. The alternating stacks of fabric layers comprise a woven fabric layer and a unidirectional fabric layer. The alternating stacks of fabric layers are adhered together.

### BRIEF DESCRIPTION OF THE DRAWINGS

FIG. 1 is a schematic illustration of an armor including a lamination according to embodiments of the disclosure;

FIG. 2 is a schematic illustration of an armor including a lamination and a plate according to embodiments of the disclosure;

FIG. 3 is a simplified view of a woven fabric layer of a lamination according to embodiments of the disclosure;

FIG. 4 is a simplified isometric view of a unidirectional fabric layer including layers of stacked fibers according to embodiments of the disclosure;

FIGS. 5A-5C are examples of lamination according to embodiments of the disclosure;

FIG. 6 is an illustration of a beaded-disrupter face plurality; and

FIG. 7 is a schematic of a continuous belt press used to compact an armor according to embodiments of the disclosure.

### DETAILED DESCRIPTION

The following description provides specific details, such as specific shapes, specific sizes, specific material compositions, and specific processing conditions, in order to provide a thorough description of embodiments of the present disclosure. However, a person of ordinary skill in the art would understand that the embodiments of the disclosure may be practiced without necessarily employing these specific details. Embodiments of the disclosure may be practiced in conjunction with conventional fabrication techniques employed in the industry. In addition, the description provided below does not form a complete process flow for manufacturing an armor (e.g., armor system). Only those process acts and structures necessary to understand the embodiments of the disclosure are described in detail below. Additional acts to form a complete armor system from the acts described herein may be performed by conventional processes.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the singular forms of the terms “a,” “an,” and “the” are intended to include the plural forms as well, unless the context clearly indicates otherwise.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, reference to an element as being “on” or “over” another element means and includes the element being directly on top of, adjacent to (e.g., laterally adjacent to, vertically adjacent to), underneath, or in direct contact with the other element. It also includes the element being indirectly on top of, adjacent to (e.g., laterally adjacent to, vertically adjacent to), underneath, or near the other element, with other elements present therebetween. In contrast, when an element is referred to as being “directly on” or “directly adjacent to” another element, no intervening elements are present.

As used herein, the term “carbon structures” means and includes all allotropes of carbon. The carbon structures may include, but are not limited to, one or more of diamond, graphite, graphene, and fullerenes. By way of example only, the carbon structures may be one or more of graphene oxide, graphene, few-layer graphene nanoplatelets, reduced graphene oxide, micronized graphite, micronized graphite oxide, micronized reduced graphite oxide, multi-wall carbon nanotubes, single wall carbon nanotubes, and carbon microspheres.

An armor including a lamination is disclosed. The lamination (e.g., laminated plurality) of the armor includes a plurality of alternating stacks of fabric layers. Each stack of the fabric layers includes woven fabric layers (e.g., woven fabrics, woven plurality) and unidirectional fabric layers (e.g., unidirectional fabrics, unidirectional plurality, non-woven fabric layers). The materials used to fabricate the woven fabric layers and the unidirectional fabric layers of the stack of fabric layers of the lamination may be reinforced with carbon structures, such as an allotrope of carbon including carbon nanostructures, and carbon microstructures. The armor is formed by providing a plurality of alternating stacks of fabric layers, each stack of the fabric layers include at least one woven fabric layer and at least one unidirectional fabric layer. The alternating stacks of fabric layers are adhered (e.g., anchored) together to form the armor. The armor may exhibit improved ballistic performance, such as improved strength, when compared to a conventional armor. For example, the armor may be used personal protective equipment and worn on the body of a person. Armor worn on the body for personal protection is conventionally referred to as body armor, or soft body armor. Soft body armor exhibits flexibility to bend in different directions providing mobility to the person wearing the soft body armor.

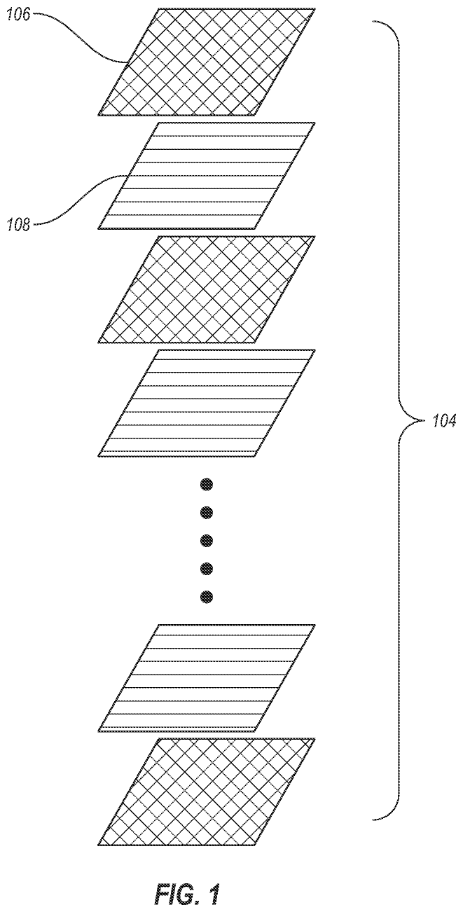

FIG. 1 is a schematic illustration of an armor (e.g., ballistic armor, soft body armor) 100 including a lamination 104 according to an embodiment of the disclosure. The lamination 104 of the armor 100 includes a plurality of alternating stacks of fabric layers. The lamination 104 includes a plurality of alternating stacks of fabric layers. The fabric layers include woven fabric layers 106 and unidirectional fabric layers 108. The lamination may include a total number of fabric layers (e.g., total fabric layers), which may be within a range of from about 2 total fabric layers to about 300 total fabric layers. More specifically, the lamination may include fabric layers within a range of from about 6 total fabric layers to about 200 total fabric layers, from about 10 total fabric layers to about 150 total fabric layers, or even from about 50 total fabric layers to about 100 total fabric layers. In some embodiments of the disclosure, the lamination may include less than 50 total fabric layers.

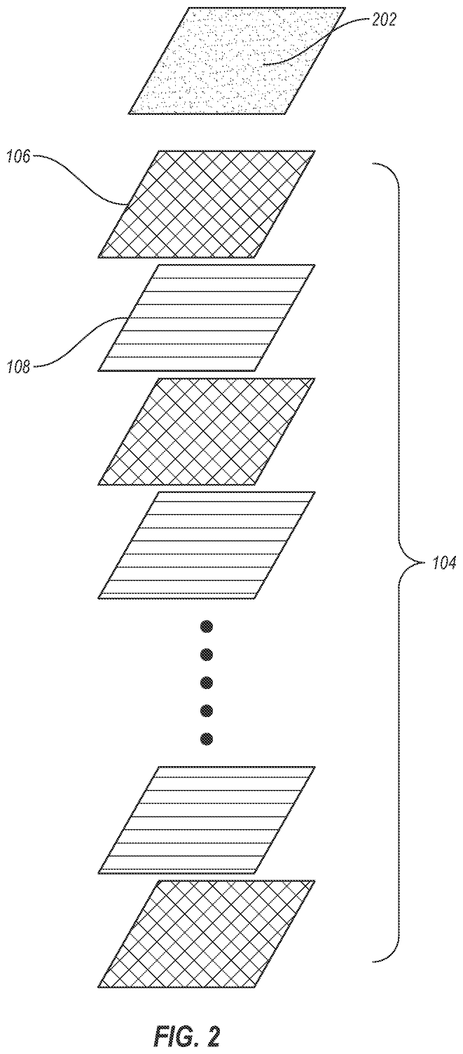

FIG. 2 is a schematic illustration of an armor 200 according to embodiments of the disclosure. The armor 200 includes a lamination 104 and a plate (e.g., strike face plurality) 202. The plate 202 is located on the top (e.g., outward facing surface) of the armor 200 and acts to disintegrate, ablate, or induce yaw upon the projectile before it reaches the lamination 104. The plate 202 may be formed of a monolithic ceramic material (e.g., hard-ceramic plate), a tiled ceramic material, or a pellet-like form attached (e.g., affixed) to the lamination 104. The material of the plate 202 may include, but is not limited to, one or more of alumina (Al₂O₃), silicon carbide (SiC), boron carbide (B₄C), silicon nitride (Si₃N₄), titanium diboride (TiB₂), carbon structures, and combinations thereof. In some embodiments, the plate is formed of a tiled ceramic material formed from Al₂O₃. In other embodiments, the plate is formed of a tiled ceramic material formed from SiC. In still other embodiments, the plate is formed of a tiled ceramic material formed from B₄C. The tiled ceramic material may be attached (e.g., affixed) to the plate by a polymeric material to provide greater flexibility to the armor 100. The pellet-like form may be encapsulated by a polymeric material and bound as a plurality.

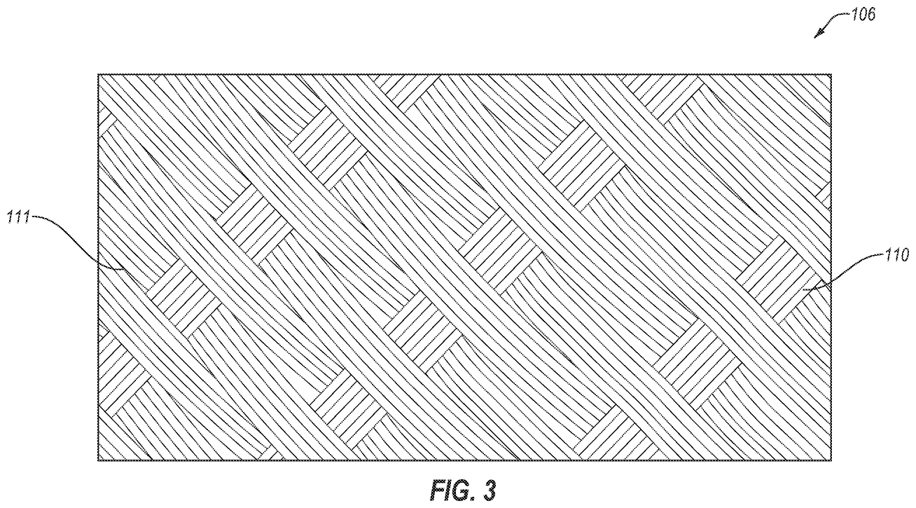

FIG. 3 is a schematic of a woven fabric layer 106 according to embodiments of the disclosure. The woven fabric layer 106 is formed of woven fibers 110 arranged in a weave pattern. The material of the woven fibers 110 may include, but not limited to, ultra-high molecular weight polyethylene, a polyolefin, a polybenzoxazole, a polyaryletherketone (PAEK), a polysulfone, a polyamide, a polyimide, an aramid, a para-aramid, a glass fiber, a carbon fiber, another ceramic fiber, or combinations thereof. Woven fabric layers 106 and woven fibers 110 within the lamination 104 may be bound with a polymeric material. The woven fibers 110 of the woven fabric layer 106 may be dyed and co-mingled (e.g., mixed together) with other dyed or un-dyed woven fibers 110 to improve the aesthetics of the lamination 104 of the armor 100. An arrangement of woven fibers 110, or weave pattern may include, but is not limited to, a plain weave, a basket weave, a twill weave, a dutch weave, or combinations thereof. FIG. 3 shows the woven fibers 110 of the woven fabric layer 106 in a basket weave pattern.

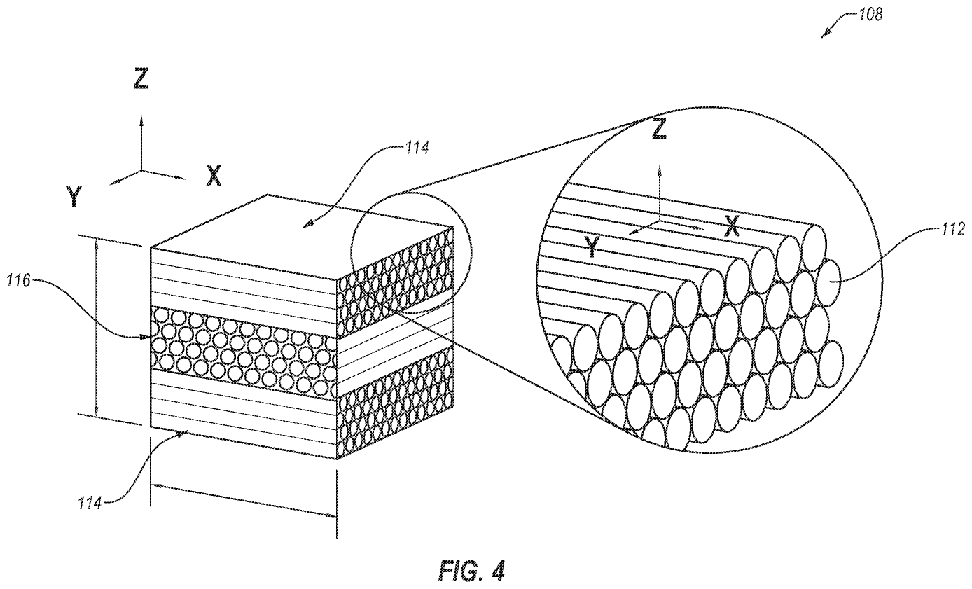

FIG. 4 shows a unidirectional fabric layer 108 according to embodiments of the disclosure. FIG. 4 is a schematic of a unidirectional fabric layer 108 where unidirectional fibers 112 are organized laterally in the X-direction (e.g., first direction) and stacked together to create a layer of fibers 114. The layer of fibers 114 is a first unidirectional fabric layer. Another layer of fibers 116 includes unidirectional fibers 112 organized laterally in the Y-direction (e.g., second direction). The other layer of fibers 116 is a second unidirectional fabric layer having parallel fibers. The layer of fibers 114, the other layer of fibers 116, and a second layer of fibers 114 are stacked together to form the unidirectional fabric layer. The layer of fibers 114 and the other layer of fibers 116 are perpendicular to each other as shown. This arrangement of stacked layers of fibers is commonly referred to as a 0 degree (e.g., length of the fibers are parallel to the X axis)/90 degree (e.g., length of the fibers are parallel to the Y axis) arrangement. Unidirectional fabric layers 108 and unidirectional fibers 112 within the lamination 104 may be bound with a polymeric material. The material of the unidirectional fibers 112 may include, but not limited to, ultra-high molecular weight polyethylene, a polyolefin, a polybenzoxazole, a PAEK, a polysulfone, a polyamide, a polyimide, an aramid, a para-aramid, a liquid- crystal, a glass fiber, a carbon fiber, another ceramic fibers, or combinations thereof.

The materials used to form the woven fibers 110 of the woven fabric layers 106 and the unidirectional fibers 112 of the unidirectional fabric layers 108 may be reinforced with carbon structures (e.g., carbon microstructures, carbon nanostructures) 111 (FIG. 3). The carbon structures including allotropes of carbon having carbon atoms stabilized in various structures with different molecular configurations. The carbon structures may include, but are not limited to, graphene oxide, graphene, few layer graphene nanoplatelets, reduced graphene oxide, micronized graphite, micronized graphite oxide, micronized reduced graphite oxide, multi-wall carbon nanotubes, single wall carbon nanotubes, carbon microspheres, or combinations thereof. The carbon structures 111 may or may not be chemically treated to improve compatibility with the materials used to form the woven fabric layers 106 and the unidirectional fabric layers 108 of the lamination 104 in which they are incorporated.

The woven fibers 110 of the woven fabric layers 106 may be secured (e.g., bonded) together with a polymeric material. The polymeric material may also be used to bond together the unidirectional fibers 112 of the unidirectional fabric layers 108. The polymeric material may include, but is not limited to, silicone, a polyurethane, a butyl, a latex rubber, an epoxy, a vinylester, a polyester, a liquid castable acrylic, a polyamide, acrylonitrile butadiene styrene (ABS), polyethylene terephthalate (PET), a PAEK, a polyimide, a polypropylene, a polyethylene, or mixtures thereof. The use of multiple polymeric materials may be used to achieve different properties, such as, stab resistance, weather resistance, and wear resistance. Securing of the woven fibers 110 within the woven fabric layers 106 and the unidirectional fibers 112 within the unidirectional fabric layers 108 with the polymeric material may prevent blades, spikes, or other sharp devices (e.g., weapons, spalling) from penetrating the plate 202 and the lamination 104 of the armor 100.

The woven fabric layers 106 and the unidirectional fabric layers 108 may be secured (e.g., anchored) together with an anchoring mechanism, such as, but not limited to, adhesives, stitching, or fasteners. There is a minimal amount of anchoring used to secure the plurality of alternating stacks of fabric layers together. To put it another way, there is a small amount of anchor points within the lamination 104. The use of the minimal anchoring within the lamination 104 may lower the risk of ballistic failure at a particular anchor point, and may mitigate the failure induced from multiple hits on the armor 100.

When used for personal protection, the armor 100 may be encased (e.g., housed) in an environmentally resistant (e.g., a water-proofed, a water-resistant) cover to provide improved environmental resistance. This cover can also act as the anchoring mechanism for the lamination 104 to reduce or eliminate anchoring points. The reduction of the anchoring points within the lamination may improve ballistic performance.

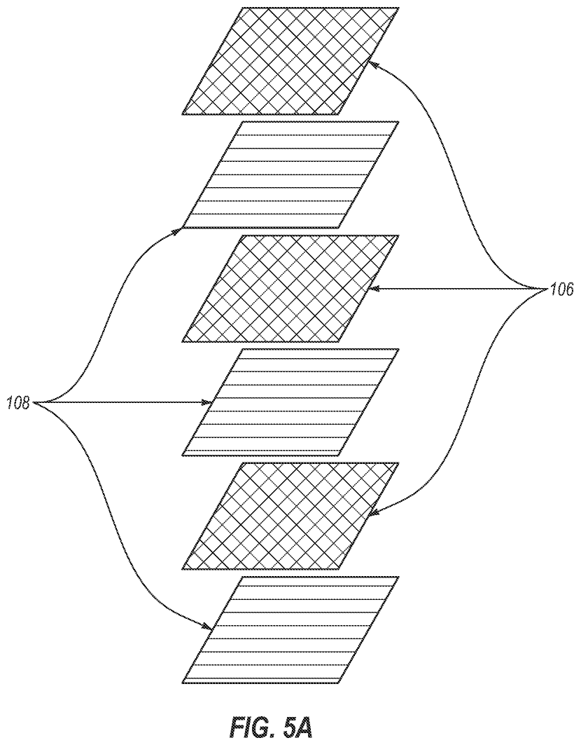

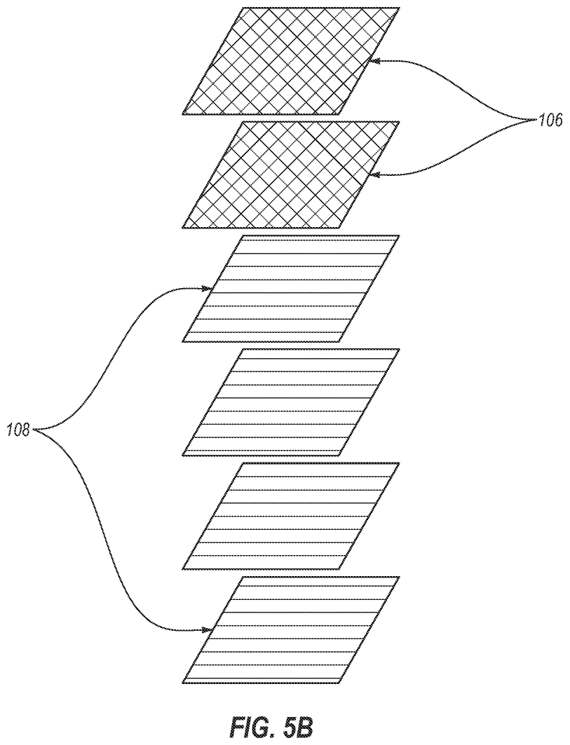

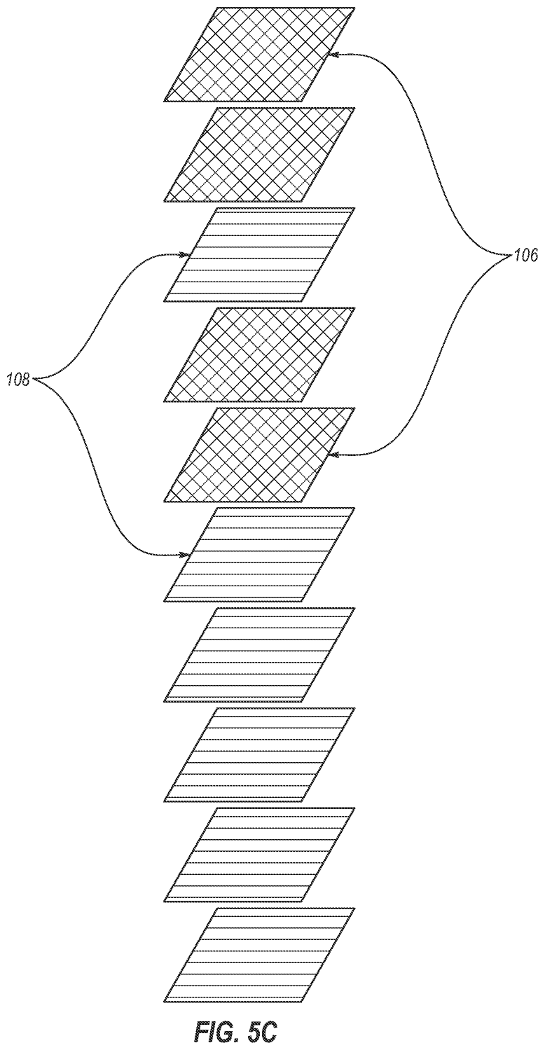

FIGS. 5A-5C show lamination sequences according to embodiments of the disclosure. The lamination sequence of FIG. 5A includes a repeating sequence of more than one woven fabric layer 106 and more than one unidirectional fabric layer 108. FIG. 5B shows a lamination sequence including a repeating sequence of two woven fabric layers 106 and four unidirectional fabric layers 108. The lamination sequence of FIG. 5C includes a repeating sequence of two woven fabric layers 106, one unidirectional fabric layer 108, two woven fabric layers 106, and five unidirectional fabric layers 108. As described above, the total number of fabric layers (e.g., the woven fabric layers 106 and the unidirectional fabric layers 108) may be within a range of from about 2 fabric layers to about 300 fabric layers. The lamination sequences of FIGS. 5A-5C may include a total number of fabric layers within this same range, or from about 2 fabric layers to about 300 fabric layers. The woven fabric layers 106 exhibit greater shear resistance than the unidirectional fabric layers 108, while the unidirectional fabric layers 108 exhibit greater tensile resistance than the woven fabric layers 106. A lamination including a plurality of alternating stacks of fabric layers may comprise a woven fabric layer 106 as a front layer and a unidirectional fabric layer 108 as a back layer. The alternating sequence of pluralities (e.g., woven plurality, unidirectional plurality), according to embodiments of the disclosure, results in the lamination exhibiting greater strength when compared to conventional monolithic armor. Additional layers (e.g., laminated pluralities, strike face pluralities, beaded-disrupter face pluralities) may be incorporated into the armor to achieve the improved mechanical properties of the armor.

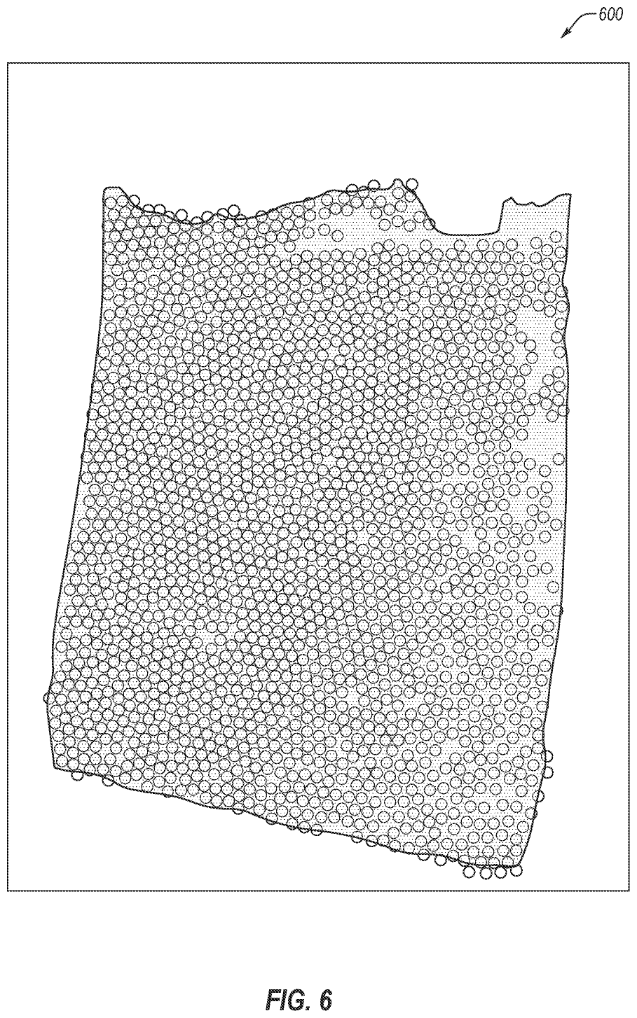

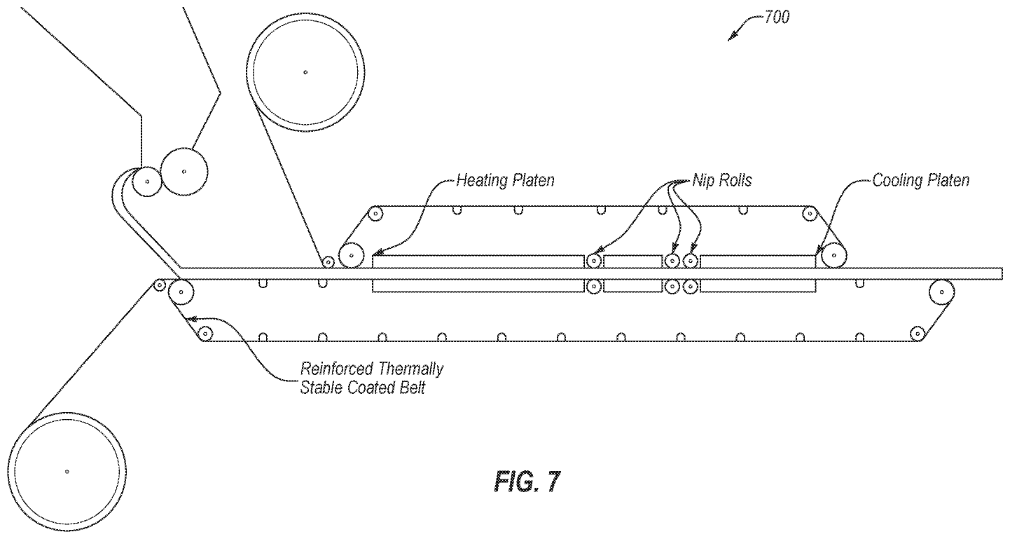

FIG. 6 shows an image of a beaded-disrupter face plurality (e.g., pellet-like form plate). The armor in accordance with embodiments of the disclosure may include a beaded-disrupter face plurality 600. The beaded-disrupter face plurality may be included in the plurality of alternating stacks of fabric layers. In accordance with embodiments of the disclosure, a method of forming the armor is disclosed. The method of forming may include providing a plurality of alternating stacks of fabric layers and adhering together the alternating stacks of fabric layers. Each stack of the fabric layers may include a woven fabric layer and a unidirectional fabric layer. In additional embodiments of the disclosure, the lamination includes a repeating sequence of woven fabric layers and unidirectional fabric layers. Each fabric layer (e.g., woven or unidirectional) may be attached together using an anchoring mechanism, such as but not limited to, adhesives, stitching, fasteners or bound by an environmentally resistant cover. Reducing the amount of anchoring mechanisms used reduces the risk of a ballistic failure at a location where the fabric layers are glued, stitched, or fastened together. The plurality of alternating stacks of fabric layers operate as an entire system to provide protection from external threats. A processing act may be performed on the fabric layers (e.g., woven fabric layers, unidirectional fabric layers) of the armor to compact the fibers of the fabric layers. The compaction of the fibers will increase the fiber packing density of the fabric layers of the armor. A continuous belt press 700 as shown in FIG. 7 may be used to perform the fiber packing density processing act.

The armor according to embodiments of the disclosure advantageously facilitates one or more of improved strength, impact resistance, and cut/abrasion protection compared to conventional armors. The methods of forming the armor according to embodiments of the disclosure facilitate the formation of ballistic armor having one or more of improved performance, reliability, durability, impact absorption and dissipation, cut/abrasion protection, and improved strength as compared to conventional ballistic systems. The armor may be inserted into a container, such as, but not limited to, a handbag, a purse, a backpack, or a chest rig. Additionally, the armor may fulfill the needs of body armor, vehicle armor, and structural armor to provide protection from projectiles, blades, or spikes.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

What is claimed is:

1. An armor, comprising:
a lamination comprising a plurality of alternating stacks of fabric layers, each stack of fabric layers, comprising:
a woven fabric layer; and
a unidirectional fabric layer.

2. The armor of claim 1, wherein the woven fabric layer comprises a carbon structure.

3. The armor of claim 1, wherein the unidirectional fabric layer comprises a carbon structure.

4. The armor of claim 1, wherein the lamination is encased in an environmentally resistant cover.

5. The armor of claim 1, further comprising a plate, wherein the plate comprises a monolithic ceramic structure, or a tiled ceramic structure.

6. The armor of claim 2, wherein the carbon structure comprises at least one of graphene oxide, graphene, few layer graphene nanoplatelets, reduced graphene oxide, micronized graphite, micronized graphite oxide, micronized reduced graphite oxide, multi-wall carbon nanotubes, single wall carbon nanotubes, carbon microspheres, and combinations thereof.

7. The armor of claim 3, wherein the carbon structure comprises at least one of graphene oxide, graphene, few layer graphene nanoplatelets, reduced graphene oxide, micronized graphite, micronized graphite oxide, micronized reduced graphite oxide, multi-wall carbon nanotubes, single wall carbon nanotubes, carbon microspheres, and combinations thereof.

8. The armor of claim 1, wherein the lamination comprises a polymeric material, the polymeric material comprising:
at least one of a silicone, a polyurethane, a butyl, a latex rubber, an epoxy, a vinylester, a polyester, a liquid castable acrylic, a polyamide, acrylonitrile butadiene styrene (ABS), polyethylene terephthalate (PET), a PAEK, a polyimide, a polypropylene, or a polyethylene.

9. The armor of claim 1, wherein the woven fabric layer comprises at least one material selected from among ultra-high molecular weight polyethylene, polyolefin fiber, polybenzoxazole fiber, PAEK, polysulfone, polyamides, polyimides, aramids, liquid-crystal, glass fiber, carbon fiber, and ceramic fiber.

10. The armor of claim 1, wherein the unidirectional fabric layer comprises at least one material selected from among ultra-high molecular weight polyethylene, polyolefin fiber, polybenzoxazole fiber, PAEK, polysulfone, polyamides, polyimides, aramids, liquid-crystal, glass fiber, carbon fiber, and ceramic fiber.

11. The armor of claim 1, wherein the plurality of alternating stacks of fabric layers comprises a repeating sequence of two woven fabric layers and four unidirectional fabric layers.

12. The armor of claim 1, wherein the plurality of alternating stacks of fabric layers comprises a repeating sequence of two woven fabric layers, one unidirectional fabric layer, two woven fabric layers, and five unidirectional fabric layers.

13. The armor of claim 1, wherein the lamination comprises a total number of fabric layers within a range extending from 2 fabric layers to 300 fabric layers.

14. The armor of claim 1, wherein the unidirectional fabric layer comprises a first unidirectional fabric layer having parallel fibers extending in a first direction, and a second unidirectional fabric layer having parallel fibers extending in a second direction, the second direction being perpendicular to the first direction.

15. A method of forming an armor, comprising:
providing a plurality of alternating stacks of fabric layers, each stack of fabric layers comprising;
a woven fabric layer;
a unidirectional fabric layer; and
adhering together the alternating stacks of fabric layers.

16. The method of claim 15, wherein providing a plurality of alternating stacks of fabric layers comprises providing a repeating sequence of one woven fabric layer and one unidirectional fabric layer.

17. The method of claim 15, wherein providing a plurality of alternating stacks of fabric layers comprises providing a repeating sequence of two woven fabric layers and four unidirectional fabric layers.

18. The method of claim 15, wherein adhering together the alternating stacks of fabric layers comprises stitching the alternating stacks of fabric layers together.

19. The method of claim 15, further comprising performing a processing act to compact the fibers of the woven fabric layer.

20. The method of claim 15, further comprising performing a processing act to compact the fibers of the unidirectional fabric layer.
